(19) United States
(12) Patent Application Publication
(10) Pub. No.: US 2003/0023510 A1
(43) Pub. Date: Jan. 30, 2003

(54) Print order receiving program, storage medium having the same therein and print order receiving device

(76) Inventors: Masataka Hasegawa, Tokyo (JP); Takashi Igarashi, Tokyo (JP); Katsutoshi Sawada, Tokyo (JP)

Correspondence Address: CANTOR COLBURN LLP, 55 Griffin Road South, Bloomfield, CT, 06002, US

(21) Appl. No.: 10/197,031

(22) Filed: Jul. 18, 2002

(30) Foreign Application Priority Data
Jul. 25, 2001 (JP) 224452/2001

(51) Int. Cl. G06F 17/60

(52) U.S. Cl. 705/26

(57) ABSTRACT

The object of the invention is to provide a print order receiving program to be executed for receiving the print order in the computer, which can perform at least the acceptable level of printing for the print order that is not based on the specific order data standard, a storage medium in which the above-mentioned program is stored, and a print order receiving device.

When the print order data are based on the specific order data standard such as DPOF, for example, since there are pre-determined the relative path in which the image data file exists and the relative path in which the file showing the data of the print quantity corresponding to the above-mentioned image data file exists, the computer can judge immediately whether the received order data are based on the specified standard or not, and when they are not based on the specified standard, the computer searches the image data file to display the corresponding the print quantity. Thus, the operator who performs the printing only inputs a specified numerical value, or inputs a default value, to be able to obtain the simplified print order data, and then the operator can perform the printing by using them.

### BACKGROUND OF THE INVENTION

The present invention relates to a print order receiving program which is executed for receiving a print order on a computer, a storage medium having stored the above-mentioned program therein, and a print order receiving device.

In recent years, an image data generating device such as a digital camera or a scanner has spread at a remarkable speed with the improvement of image processing technologies. Due to this, consciousness of users who use the image data generating device about a digital image is growing more and more, and the image data generating device has been used in various uses such as home page making of the Internet or digital printing. On the other hand, in a conventional photofinishing laboratory (hereinafter referred to as lab), where a print has been produced from a negative film mainly, while in a print outputting center that performs an image print service, a mini lab (a small-sized photofinishing lab or a photo shop having a printer) and a large-sized lab performing a centralized processing, the service that handles digital image data increases with the spread of the digital camera, accordingly, the service variations are diversified.

On the other hand, with the spread of the Internet into the general homes, it has been performed that a client uploads image data via the Internet to the server controlled by the lab, and the lab produces the print based on the image data uploaded, to provide the print to the client, as an example of the service that handles such digital image data. By this service, the client can place an order of the print for the image data which the client owns, while the client stays in house, which is an advantage. Further, the client can perform a print order and receive the same service as the above-mentioned service, when the client brings a medium in which an image data is stored therein to an agent, for example.

Here, when the client places a print order based on the image data, the client can use a standard named DPOF (Digital Print Order Format) established by CANON INC., Eastman Kodak Co., Fuji Photo Film Co., LTD., and Matsushita Electric Industrial Co., Ltd., which took a leading part. Since this standard requires to form a prescribed path structure in an order data, when the client places the print order via a network, an order data receiving section can extract the image data and the order data in accordance with DPOF, and can perform proper printing by using these data.

Incidentally, though DPOF is used mainly for the digital camera, there is a case that each dealer providing the print service makes the print order data by its own plan to produce the print for the client. However, when the order is placed by the use of the above-mentioned order data, a section which has received the order cannot understand content of the order data, and cannot determine the printing mode. In this case, the order data needs to be sent back, which is time-consuming, and postponing of the print delivering date, and resultantly, there occurs the problem that the client cannot receive the print on the expected date.

The present invention has been achieved in view of the above-mentioned problems. The object of the invention is to provide a print order receiving program to be executed for receiving the print order in the computer, which can perform at least the acceptable level of printing for the print order that is not based on the specific order data standard, a storage medium in which the above-mentioned program is stored, and a print order receiving device.

### SUMMARY OF THE INVENTION

The object of the present invention is attained by either one of the following structures.

Structure (1) In the print order receiving program of the first invention, which is a program for receiving a print order in a computer, by executing the above-mentioned print order receiving program, the computer judges whether the print order data are based on the prescribed format wherein a relative path having an image data file and a relative path having a file showing data of prints quantity corresponding to the above-mentioned image data file are prescribed, and when the print order data are not based on the prescribed format, the computer automatically specifies a path of an image data file existing in the print order data, and the computer makes a display to show the instruction of inputting of the print quantity based on the image data file to which the path has been specified, and when the print order data are based on the specific order data standard such as DPOF, for example, since there are pre-determined the relative path in which the image data file exists and the relative path in which the file showing the data of the print quantity corresponding to the above-mentioned image data file exists, the computer can judge immediately, based on the paths, whether the received order data are based on the specified standard or not, and when they are not based on the specified standard, the computer searches the image data file to display the print quantity corresponding to the image data file. Thus, the operator who performs the printing only inputs a specified numerical value, or inputs a default value, to be able to obtain the simplified print order data, and then the operator can perform the printing by using them. Incidentally, it is indispensable to display “the instruction of inputting of the print quantity”, while, it is optional to display “the instruction of inputting of the print size”.

Further, it is preferable that not only the instruction of inputting of the print quantity but also the thumbnail image corresponding to it are displayed, because it is possible to know what kind of image is going to be printed. For example, when the solid black image caused by erroneous exposure is displayed, the operator can eliminate the printing of this image at this step.

Further, it is more preferable that the path structure including the image data file is indicated on the display, because it is possible to know what type of the path structure is included, at a glance.

Still further, concerning the above-mentioned path structure that is displayed on the display, it is convenient that the path including the image data file and the path not including the image data file are displayed separately, because it is easy to seek for the image data file. It is possible to assume whether the file in the path is the image data file or the file other than the image data file, from an extension of the file or the volume of the file.

Still further, it is convenient that a representative image concerning the included image data file is displayed in the path including the above-mentioned image data file, because it is easy to find the particular image data file.

Still further, when the above-mentioned image data file includes the image data of the thumbnail image, the thumbnail image having lower leveled image quality is prevented from being printed, by discriminating the image data of the thumbnail image, which is preferable. The following is a method to discriminate between the image data of the regular image and the image data of the thumbnail image in the image data file, for example. That is, in the method, the volume of each image data file is analyzed statistically and is divided into a range of the volume of the group of the regular image and a range of the volume of the group of the thumbnail image, then the belonging range of the image data file is discriminated, based on the range to which the particular image data file belongs.

Structure (2) In the storage medium of the second invention, which has stored the print order receiving program for receiving the print order using the computer, and can be read by the computer, by executing the above-mentioned print order receiving program, the computer judges whether the print order data are based on the prescribed format wherein a relative path having an image data file and a relative path having a file showing data of print quantity corresponding to the above-mentioned image data file are prescribed, and when the print order data are not based on the prescribed format, the computer automatically specifies a path of an image data file existing in the print order data, and the computer makes a display to show the instruction of inputting of the print quantity based on the image data file to which the path has been specified, and when the print order data are based on the specified order data standard such as DPOF, for example, since there are pre-determined the relative path in which the image data file exists and the relative path in which the file showing the data of the print quantity corresponding to the above-mentioned image data file exists, the computer can judge immediately, based on the paths, whether the received order data are based on the specified standard or not, and when they are not based on the specified standard, the computer searches the image data file to display the print quantity corresponding to the image data file. Thus, the operator who performs the printing only inputs a specified numerical value, or inputs a default value, to be able to obtain the simplified print order data, and then the operator can perform the printing by using them.

Further, it is preferable that not only the instruction of inputting of the print quantity but also the thumbnail image corresponding to it are displayed, because it is possible to know what kind of image is going to be printed. For example, when the solid black image caused by erroneous exposure is displayed, the operator can eliminate the printing of this image at this step.

Further, it is more preferable that the path structure including the image data file is indicated on the display, because it is possible to know what type of the path structure is included, at a glance.

Still further, concerning the above-mentioned path structure that is displayed on the display, it is convenient that the path including the image data file and the path not including the image data file are displayed separately, because it is easy to seek for the image data file. It is possible to assume whether the file in the path is the image data file or the file other than the image data file, from an extension of the file or the volume of the file.

Still further, it is convenient that a representative image concerning the included image data file is displayed in the path including the above-mentioned image data file, because it is easy to find the particular image data file.

Still further, when the above-mentioned image data file includes the image data of the thumbnail image, the thumbnail image having lower leveled image quality is prevented from being printed, by discriminating the image data of the thumbnail image, which is preferable. The following is a method to discriminate between the image data of the regular image and the image data of the thumbnail image in the image data file, for example. That is, in the method, the volume of each image data file is analyzed statistically and is divided into a range of the volume of the group of the regular image and a range of the volume of the group of the thumbnail image, then the belonging range of the image data file is discriminated, based on the range to which the particular image data file belongs.

Structure (3) The print order receiving device which receives the print order, of the third invention, includes a judging means that judges whether the print order data are based on the prescribed format wherein a relative path having an image data file and a relative path having a file showing data of prints quantity corresponding to the above-mentioned image data file are prescribed, a path specifying means that automatically specifies a path of an image data file existing in the print order data, when the print order data are not based on the prescribed format, and a display that indicates the instruction of inputting of the print quantity based on the image data file to which the path has been specified. Accordingly, when the print order data are based on the specified order data standard such as DPOF, for example, since there are pre-determined the relative path in which the image data file exists and the relative path in which the file showing the data of the print quantity corresponding to the above-mentioned image data file exists, the computer can judge immediately, based on the paths, whether the received order data are based on the specified standard or not, and when they are not based on the specified standard, the computer searches the image data file to display the print quantity corresponding to the image data file. Thus, the operator who performs the printing only inputs a specified numerical value, or inputs a default value, to be able to obtain the simplified print order data, and then the operator can perform the printing by using them.

Further, it is preferable that not only the instruction of inputting of the print quantity but also the thumbnail image corresponding to it are displayed, because it is possible to know what kind of image is going to be printed. For example, when the solid black image caused by erroneous exposure is displayed, the operator can eliminate the printing of this image at this step.

Further, it is more preferable that the path structure including the image data file is indicated on the display, because it is possible to know what type of the path structure is included, at a glance.

Still further, concerning the above-mentioned path structure that is displayed on the display, it is convenient that the path including the image data file and the path not including the image data file are displayed separately, because it is easy to seek for the image data file. It is possible to assume whether the file in the path is the image data file or the file other than the image data file, from an extension of the file or the volume of the file.

Still further, it is convenient that a representative image concerning the included image data file is displayed in the path including the above-mentioned image data file, because it is easy to find the particular image data file.

Still further, when the above-mentioned image data file includes the image data of the thumbnail image, the thumbnail image having lower leveled image quality is prevented from being printed, by discriminating the image data of the thumbnail image, which is preferable. The following is a method to discriminate between the image data of the regular image and the image data of the thumbnail image in the image data file, for example. That is, in the method, the volume of each image data file is analyzed statistically and is divided into a range of the volume of the group of the regular image and a range of the volume of the group of the thumbnail image, then the belonging range of the image data file is discriminated, based on the range to which the particular image data file belongs.

In the present specification, the image data generally mean digitized image data, and to put it more concretely, they mean the digitized data obtained by quantizing the information representing a transmission-type original such as a negative film or a positive film and a reflection-type original such as photographic paper or printed matter, or mean directly memorized data as digital information like a digital camera, and further mean image data (generally CG) which are designed optionally on a computer by the client.

Incidentally, the path in this case is called a folder in an operating system (OS) of Windows 95/98/98SE/2000 (made by Microsoft Corporation), and there are OSs which call it a directory, and all of them are the same conceptually, further, let it be assumed that the other OSs also include the same conception as the above-mentioned path.

### BRIEF DESCRIPTION OF THE DRAWINGS

FIG. 1 is a schematic drawing showing a total network system including a print order receiving device related to the present embodiment.

FIG. 2 is a flowchart showing an operation of order processing computer 23 in a photo shop.

FIG. 3 is a drawing showing an exemplified path construction of order data based on DPOF standard.

FIG. 4 is a drawing showing a retrieval result displayed on display 23b of order processing computer 23.

FIG. 5 is a drawing showing the example of a path construction displayed on display 23b.

FIGS. 6(a) and 6(b) are drawings showing an exemplified path construction of order data which are customized by the client.

### DETAILED DESCRIPTION OF THE PREFERRED EMBODIMENT

The present invention will be described in detail below, referring to the preferred embodiment.

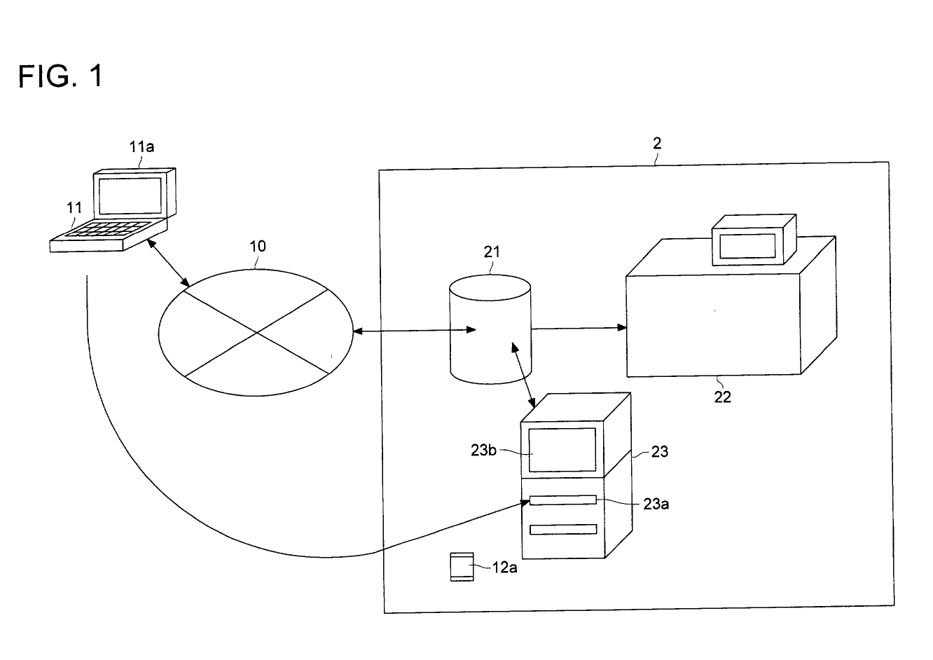

FIG. 1 is a schematic drawing showing the total network system including the print order receiving device relating to the present embodiment. Terminal 11 of the client is connected to WAN 10 (Wide Area Network) represented by a network such as the Internet to be capable of communicating data, via devices such as an unillustrated router or modem for connecting the terminal or LAN to the Internet.

On the other hand, print order server 21, printer 22, and order processing computer (print order receiving device) 23 including media drive 23a for inputting order data, all installed in photo shop 2, are connected each other by a single LAN, and connected to WAN 10 to be capable of communicating data via devices such as an unillustrated router or modem.

The flow of the print order is shown, based on FIG. 1. When a client wants the print of the image, based on image data prepared by an unillustrated digital still camera, or by the terminal 11, the client forms the order data including the image data. The formed order data can be sent to the print order server 21 via WAN 10 to be stored, or the formed order data being under the condition stored in media 12a can be brought to the photo shop 2 by the client, and can also be read out by the media drive 23a to be stored in the print order server 21.

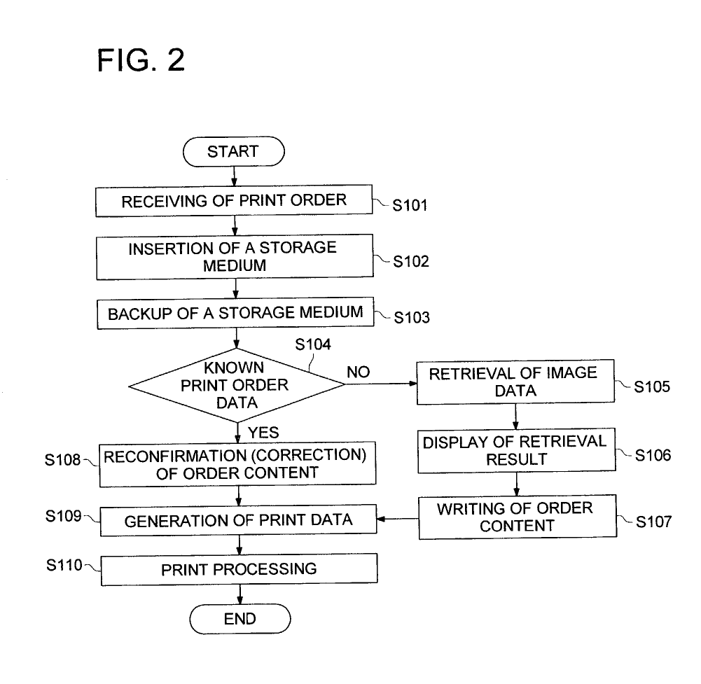

FIG. 2 is a flowchart showing the operation of the order processing computer 23 in photo shop 2. Incidentally, in FIG. 2, there is described the condition that the print order is received based on the order data (including an image data file) stored in the media brought by the client, however, the order data sent via WAN 10 can also be processed, by being inputted to the order processing computer 23 via the print order server 21.

The order processing computer 23 starts print order receiving processing (by starting up the print order receiving program from a hard disk representing the storage medium) in step S101, and the order data read out from the media drive 23a are stored (for backing-up of data) in a prescribed memory area temporarily in step S103, when the media 12a is introduced to the media drive 23a in step S102, which is preferable. The foregoing is for the sake of performing the following process at high speed, or because of a fear that the order data are erased by accident, if the media 12a is one being an over-writing type. Though there is not illustrated, when the normal ending of the print order processing is recognized, the backed-up order data are erased.

Further, the order processing computer 23 judges whether the order data based on a prescribed format such as DPOF standard exist in the media 12a or not, in step S104.

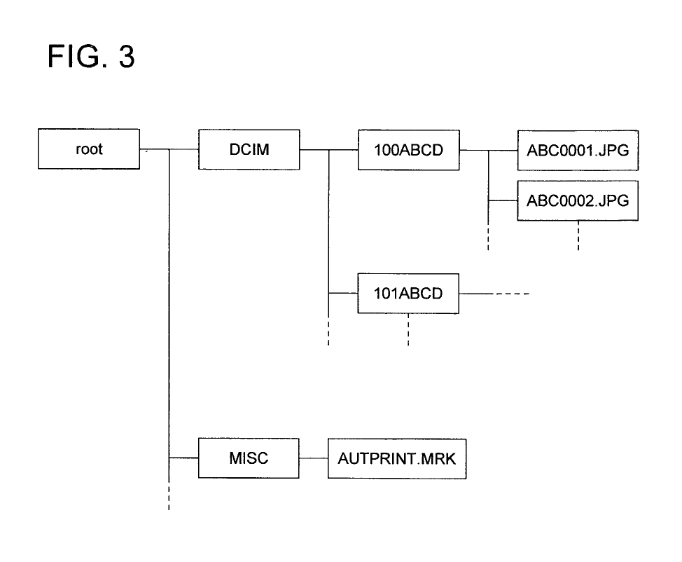

Here, there is described the judging method whether the order data based on the prescribed format such as DPOF standard exist in the media 12a or not. FIG. 3 is a drawing showing an exemplified directory structure of the order data based on DPOF standard. In FIG. 3, the order processing computer 23 judges whether a file (including the data of file name of corresponding image data, the data of print quantity, and the data of the print size) named “AUTPRINT. MRK” exists in a directory named “MISC” or not. To put it concretely, the order processing computer 23 representing a checking means and a path specifying means retrieves the order data to judge whether a relative path named “¥MISC¥AUTPRINT. MRK” exists or not, and whether an image file specified by “AUTPRINT.MRK” file exists in a directory named “¥DCIM” or not. If the relative path exists, the order processing computer 23 determines that the order data are based on the prescribed format such as DPOF standard, and if not, the order processing computer 23 can determine that the order data are not based on the prescribed format such as DPOF standard.

Here, the following is the reason why the relative path is used for judging whether the data are based on the prescribed format or not. That is, for example, though the client forms the order file one by one by DPOF, there is a case that the order file is stored in a disk having a large volume, such as the media for the digital camera especially, and in this case, there is considered that the client forms an optional directory to put together on the upper level of the directory formed in accordance with the standard.

When the order processing computer 23 judges that the order data are based on the prescribed format such as DPOF standard, it is possible to process the order data in accordance with the step of the applicable standard, and accordingly, the order processing computer 23 confirms the order contents such as the print size and the print quantity, and corrects the order contents in case of need in step S108, then makes the print data (the order contents and the image data transformed to the format which the printer 22 can read), and sends them to the print order server 21, then the print data are memorized in a print waiting area, and inputted to the printer 22 in succession so that the printer 22 performs the print processing (step S110).

On the other hand, when the order processing computer 23 judges that the order data are not based on the prescribed format such as DPOF standard, the order processing computer 23 retrieves the order data to perform the file sampling of the image data, in step S105. Here, the file sampling of the image data can be performed in a manner that the extensions of files being “JPG” or “BMP”, for example, are specified to be the image data immediately. Or, apart from this, or in addition to this, when the file volume is equal to or larger than the prescribed value (20 KB, for example), it can be judged that the image data file is on the level printable.

Here, there is a case that the image data file of the thumbnail image corresponding to the regular image wanted to be printed is included in the order data, which is a problem. Because there is a fear that the image having a lower image quality used for a list indication on the display may be printed, when the printing is performed in accordance with the above-mentioned image data file. To solve this problem, after sampling all of the image data files and by conducting the statistical processing beforehand, two groups having the different range of the volume respectively are obtained, such as the file group of the regular images (equal to or greater than 100 KB, for example) and the file group of the thumbnail images (equal to or less than 50 KB, for example), accordingly, the order processing computer 23 relating to the present embodiment can determine the image data file whether it relates to the regular image or the thumbnail image, in accordance with the volume of the specified image data file. Incidentally, when the order processing computer 23 determines that the image data file relates to the thumbnail image, the order processing computer 23 can display the alarm message, for example, making the default value of the print quantity to be zero, while making the print quantity of the default determined to be related to the regular image to be one.

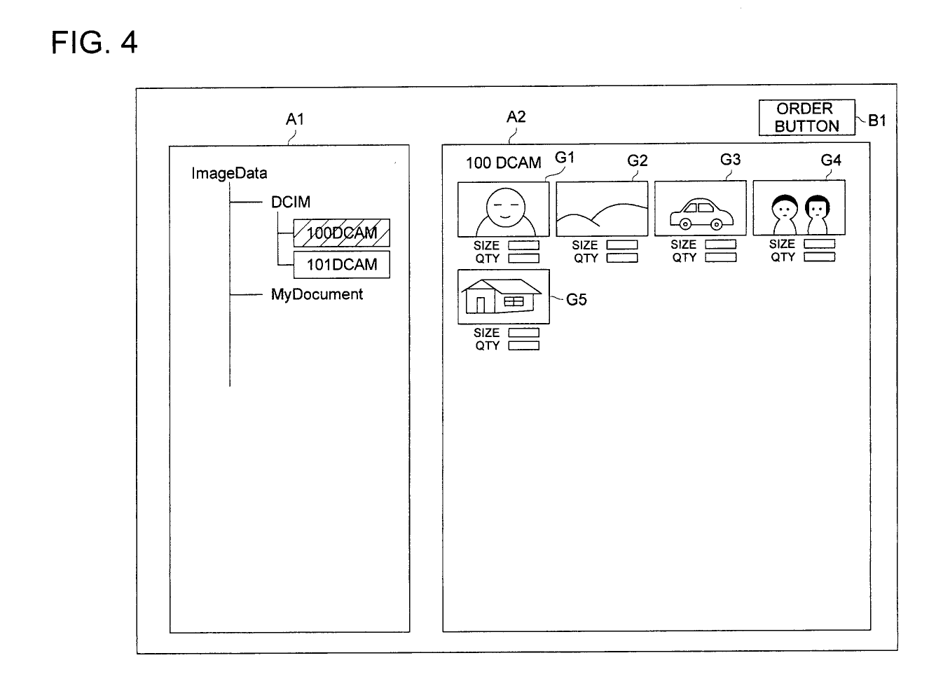

By the above-mentioned processing, the order processing computer 23 displays the retrieved result on display 23b, after determining that the image data file relates to the thumbnail image. FIG. 4 is a drawing showing the retrieved result displayed on the display 23b.

In FIG. 4, the directory construction included in the order data is shown on area A1 of the left side of the screen, and the directory (“100DCAM”, “101DCAM”, in this case) including the image data file can be recognized at a glance to include the image data file, by being given a frame to its characters. Incidentally, various method such as the changing of color of the characters, or the reversal of the characters are considered to indicate that the image data file is included.

Here, when the operator clicks the directory “100DCAM”, for example, the thumbnail images G1-G5, which are made based on the image data file included in the directory “100DCAM”, are displayed on the area A2 on the right side of the screen, and at the same time, sections for the print size and the print quantity are displayed under each thumbnail image G1-G5. The operator inputs the print size and the print quantity onto each section (step S107 of FIG. 2), and clicks order button B1, then in the step S109, the print processing computer 23 forms the print data which can be inputted by the printer 22, and sends the print data to the print order server 21 to be stored in a print waiting area, then the print data are inputted to the printer 22 in succession, to perform the print processing (step S110).

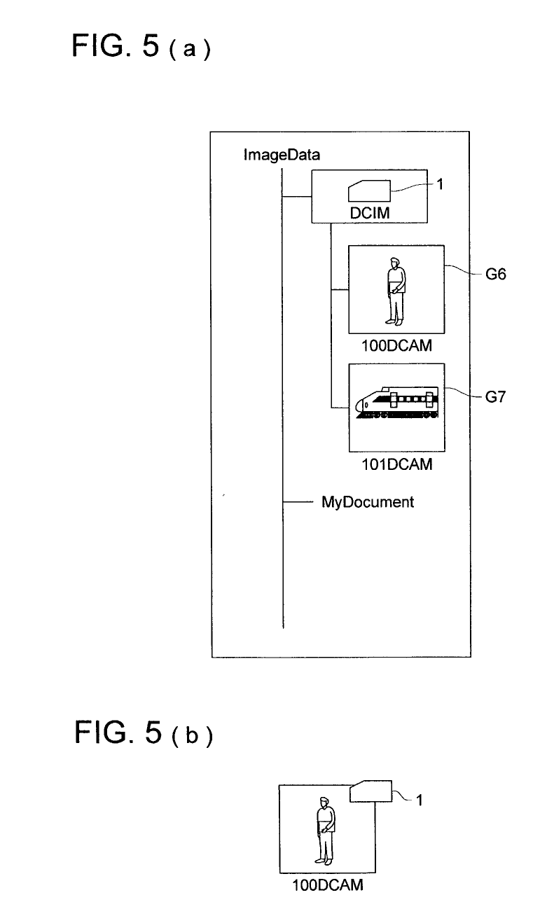

FIG. 5(a) is a drawing showing an example of the path structure shown on the display 23b. Here, icon I is shown on a name of directory “DCIM”, which means the directories (“100DCAM” and “101DCAM” in this case) including the image data files are under the directory “DCIM”. Further, thumbnail images G6 and G7 representing the image data files included in each directory are displayed on the names of “100DCAM” and “101DCAM” respectively. Here, it is conceivable that “image representing the image data file” is the image based on the data files at the prescribed position such as top, end or center in the order of retrieval, when there exist a plurality of image data files in the same directory. Incidentally, when the directory “100DCAM” includes the image data file and the directory having the image data file on the same rank, icon I is shown on the upper right side of the thumbnail image G6, as shown in FIG. 5(b), and due to this, it is possible to distinguish the directory from the other directory (see FIG. 5(a)).

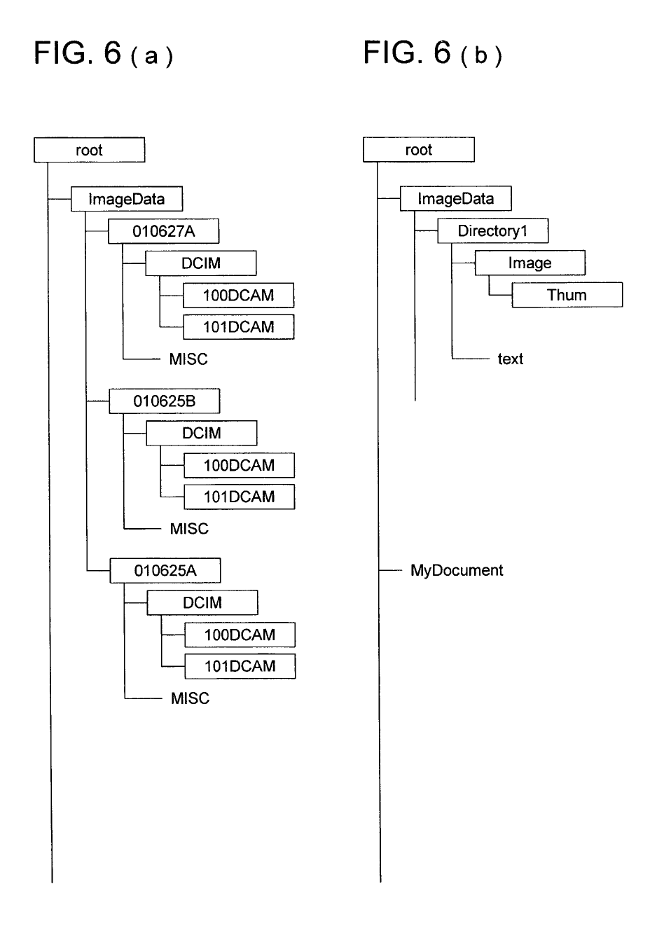

FIG. 6 is a drawing showing the exemplified path structure of the order data which is customized by the client. The example shown in FIG. 6(a) is one in that the directory named “ImageData” is formed under the directory “root”, and directory named “010627A” showing the date is formed under the directory “ImageData”. Further, directory “DCIM” and directory “MISC” which are used for DPOF standard are formed under the directory “010627A”. In this case, if there is the file named “AUTPRINT. MRK” in the directory named “MISC”, and if “DCIM” can be detected by the relative path named “¥MISC¥AUTPRINT. MRK”, the print data can be formed based on the DPOF standard.

In the example shown in FIG. 6(b), the process starts from step S105 of FIG. 2, because the directory “MISC” does not exist. Incidentally, though described is the example in which the order receiving computer 23 is used, it is also possible to send the order data to the photo shop via WAN such as the Internet, after distributing a software having the same function in a form of CD-ROM to the clients, further by installing it onto the terminal 11 of the client.

As mentioned above, the present invention has been explained referring to the embodiment, but the invention should not be interpreted by limiting to the above-mentioned embodiment, and needless to say, it is possible to modify and to improve the embodiment appropriately.

The present invention provides the print order receiving program which is run when the print order is received in the computer, the storage media having the same, and the print order receiving device, by which the acceptable printing can be performed, even when there exists the print order which does not follow the specified order data standard, accordingly it is possible to perform the printing service having high productivity.

What is claimed is:

1. A print order receiving program for receiving a print order by using a computer, comprising:
a receiving program for receiving print order data with a relative path in which a image data file and a print quantity data file are stored;
a judging program for judging whether a type of the relative path is a prescribed type or not;
a type specifying program for specifying the type of the relative path when the type of the relative path is judged to be not the prescribed type; and
a displaying program for indicating an input request for a print quantity on the basis of the image data file stored in the type-specified relative path.

2. The print order receiving program of claim 1, wherein the display displays a thumbnail image and the input instruction of the print quantity corresponding to the thumbnail image.

3. The print order receiving program of claim 1, wherein a path structure including the image data file is displayed.

4. The print order receiving program of claim 3, wherein the path structure is displayed being separated into the relative path including the image data file and the relative path not including the image data file.

5. The print order receiving program of claim 4, wherein in the relative path including the image data file, a representative image concerning the included image data file is displayed.

6. The print order receiving program of claim 1, wherein when the image data file includes the image data of the thumbnail image, the image data of the thumbnail image is discriminated.

7. A storage medium, being readable by a computer, and storing therein a print order receiving program for receiving a print order by using a computer, comprising;
a receiving program for receiving print order data with a relative path in which a image data file and a print quantity data file are stored;
a judging program for judging whether a type of the relative path is a prescribed type or not;
a type specifying program for specifying the type of the relative path when the type of the relative path is judged to be not the prescribed type; and
a displaying program for indicating an input request for a print quantity on the basis of the image data file stored in the type-specified relative path.

8. The storage medium, being readable by a computer, and storing a print order receiving program of claim 7, wherein the display displays a thumbnail image and the input instruction of the print quantity corresponding to the thumbnail image.

9. The storage medium, being readable by a computer, and storing a print order receiving program of claim 7, wherein a path structure including the image data file is displayed.

10. The storage medium, being readable by a computer, and storing a print order receiving program of claim 9, wherein the path structure is displayed being separated into the relative path including the image data file and the relative path not including the image data file.

11. The storage medium, being readable by a computer, and storing a print order receiving program of claim 10, wherein in the relative path including the image data file, a representative image concerning the included image data file is displayed.

12. The storage medium, being readable by a computer, and storing a print order receiving program of claim 7, wherein when the image data file includes the image data of the thumbnail image, the image data of the thumbnail image is determined.

13. A print order receiving device for receiving a print order, comprising;
a receiving section for receiving print order data with a relative path in which a image data file and a print quantity data file are stored;
a judging section for judging whether a type of the relative path is a prescribed type or not;
a type specifying section for specifying the type of the relative path when the type of the relative path is judged to be not the prescribed type; and
a displaying section for indicating an input request for a print quantity on the basis of the image data file stored in the type-specified relative path.

14. The print order receiving device for receiving a print order of claim 13, wherein the displaying section displays a thumbnail image and the input instruction of the print quantity corresponding to the thumbnail image.

15. The print order receiving device for receiving a print order of claim 13, wherein a path structure including the image data file is displayed.

16. The print order receiving device for receiving a print order of claim 15, wherein the path structure is displayed being separated into the relative path including the image data file and the relative path not including the image data file.

17. The print order receiving device for receiving a print order of claim 16, wherein in the relative path including the image data file, a representative image concerning the included image data file is displayed.

18. The print order receiving device for receiving a print order of claim 13, wherein when the image data file includes the image data of the thumbnail image, the image data of the thumbnail image is determined.
